(19) United States
(12) Patent Application Publication
(10) Pub. No.: US 2017/0158110 A1
(43) Pub. Date: Jun. 8, 2017

(54) LOCKING APPARATUS OF CONTAINER FOR TRAILER

(71) Applicants: Hyon IL JO, Busan (KR); Kwang Heui HAN, Busan (KR); Jae Min CHO, Busan (KR)

(72) Inventor: Hyon IL JO, Busan (KR)

(21) Appl. No.: 14/958,746

(22) Filed: Dec. 3, 2015

(51) Int. Cl. B60P 7/13

(52) U.S. Cl. CPC B60P 7/13

(57) ABSTRACT

The present invention provides a locking apparatus of a container for a trailer that can fixing a container by automatically or manually coupling the container to a trailer, using a locking pin that is operated by the weight of a container, and can improve stability by preventing movement and separation of a container from a trailer in transportation. The locking apparatus includes: an outer housing; an inner housing; an automatic actuator; a locking pin having a cylindrical body, a head, a first locking protrusion, and a guiding portion; a guide member; and a manual actuator having an extension, a length adjusting portion, and a lever.

### BACKGROUND OF THE INVENTION

Field of the Invention

The present invention relates to a locking apparatus of a container for a trailer and, more particularly, to a locking apparatus of a container for a trailer that allows for automatic or manual coupling and fixing of a container to a trailer by means of a locking pin, which is operated by the weight of the container, and that can improve stability by preventing movement and separation of a container by form firmly fixing the container while a trailer is driven.

Description of the Related Art

In general, a container, which is a type of transportation case, refers to a large box made in a specific size to safely and conveniently transport large freight by land or by sea. Further, it is a box standardized for large freight.

Containers are carried by container trucks on land and a large number of containers are carried by large container ships that are designed to be loaded with containers while at sea.

Vehicles called trailers are used as transportation for transporting containers on land and are pulled by another vehicle, such as a tractor, without common power generating system and control system.

Trailers are designed to carry the various sizes of standardized containers. The weight of containers when they are loaded with freight is also considered when designing trailers. Trailers designed in this way are loaded with one or more containers and are equipped with a locking apparatus for fixing containers on the trailers in order to prevent movement and separation of the containers on the trailers due to sudden braking, turns, slopes on a road, and other sudden situations.

The locking apparatus is mandatory by law and manual and automatic types have been proposed.

FIGS. 1A and 1B are cross-sectional views showing a manual locking apparatus according to the related art before and after the locking apparatus is operated.

A manual locking apparatus of the related art, as shown in FIGS. 1A and 1B, includes locking pins 2 disposed on a top frame 1 of a trailer to be locked and unlocked by a lever 3 that is rotated and moved up/down, so when a driver operates the lever 3 of a locking pin 2 with a container 4 mounted at a predetermined position on the top frame 1, a head 2′ at the upper end of the locking pin 2 is inserted into a fastening hole 5 formed in the bottom of the container 4.

That is, this manual locking apparatus is supposed to ensure stability during transportation by fastening a trailer and a container on the trailer.

However, most drivers usually drive without locking this locking apparatus due to a reason that it is troublesome to lock the locking apparatus with containers mounted, and when they drive on particularly uneven roads or perform sharp turns without the containers locked, a large accident may occur, for example, the containers are separated or dropped from the trailer.

An automatic locking apparatus has bee proposed in Korean Utility Model No. 20-0186762 in order to solve these problems.

FIGS. 2A and 2B are cross-sectional views shows an automatic locking apparatus according to the related art before and after the locking apparatus is operated.

This automatic locking apparatus, as shown in FIGS. 2A and 2B, includes: an actuator 20 that is disposed in a housing disposed on a top frame of a trailer and has a hollow portion 21 protruding upward by elasticity of an elastic sprint 22 and an external load; a locking pin 30 that is coaxially disposed through the hollow portion 21 of the actuator 20 and has a head 31 that is inserted into a container and a flange 32 that is operated in contact with the actuator 20; a slit 41 that is formed in a hole 40, which is formed in the locking pin 30 at a predetermined depth from the bottom of the locking pin 30, and has a curved surface for rotating the locking pin 30 moving down within a predetermined range; a support shaft 50 that is fixed to a cover 11 coupled to the bottom of the housing 10 and is freely slid by an elastic spring 52 in the hole 40; and a pin 51 that is formed on the outer side at an upper portion of the support shaft 50 and changes the direction of the locking pin 30 moving up/down along the slit with respect to the portion inserted in the slit 41.

That is, the automatic locking apparatus can be automatically locked and unlocked by its own weight when a container is loaded and unloaded, so it is possible to safely lock and transport heavy containers and remove the inconvenience of requiring manual locking of the locking pin.

However, when there is a problem with the parts in the automatic locking apparatus of the related art, normal locking and unlocking is not made, so in order to solve this problem, it is required to disassemble and separate the locking apparatus from a trailer and then replace it with a new one.

Further, horizontal shock is applied to a container when a trailer is suddenly started, braked, and turned, in which shock is directly applied to the locking pin, the hollow portion, and the actuator fastened to the container, thus the parts coupled to the locking pin are damaged, so durability decreases and malfunction is generated.

Containers are generally loaded/unloaded onto/from trailers by exclusive equipment or a forklift, but in this process, the head of the locking pin is not accurately inserted in a fastening hole of the containers in some cases. In this case, the weight of a container is directly applied not to the actuator, but to the head of the locking pin, so the locking pin is not normally inserted and is moved downward, and accordingly, the parts coupled to the locking pin may be damaged and fastening is not normally made.

### DOCUMENTS OF RELATED ART

(Patent Document 1) KR10-2010-0056538 A

(Patent Document 2) KR10-0182902 B1

### SUMMARY OF THE INVENTION

Accordingly, the present invention has been made keeping in mind the above problems occurring in the related art, and the present invention is intended to propose a locking apparatus of a container for a trailer that can be easily manually locked and unlocked even if it cannot be normally automatically locked and unlocked due to malfunction.

Further, the present invention provides a highly durable locking apparatus of a container for a trailer that can minimize malfunction by preventing direct shock to a locking pin due to a horizontal load applied to a container.

Further, the present invention provides a locking apparatus of a container for a trailer that can prevent parts coupled to a locking pin from being damaged and can allow normal fastening, even if a head of the locking pin is not accurately inserted in a fastening hole of a container.

It should be noted that objects of the present invention are not limited to the above-mentioned object and other objects of the present invention will be apparent to those skilled in the art from the following descriptions.

In order to achieve the above object, according to one aspect of the present invention, there is provided a locking apparatus of a container for a trailer that can fixing a container by automatically or manually coupling the container to a trailer, using a locking pin that is operated by the weight of a container, and can improve stability by preventing movement and separation of a container from a trailer during transportation. The locking apparatus includes: an outer housing mounted on the upper frame and having an opening at least at a side; an inner housing having the shape of a hollow pipe and disposed inside the outer housing with a gap therebetween; an automatic actuator disposed in the inner housing and moved up and down by a first elastic member and the weight of a container; a locking pin having a cylindrical body disposed in the automatic actuator, a head formed at an upper end of the body and inserted in a fastening hole of the container, a first locking protrusion formed at a portion around the outer side of the body and moved with the automatic actuator moving up and down, and a guiding portion formed at another portion around the body and inducing the body to be rotated with the automatic actuator moving up and down; a guide member separably inserted toward the automatic actuator from the outside of the inner housing such that an end is coupled to the guiding portion and rotating the locking pin when the automatic actuator moves up and down; and a manual actuator having an extension separably coupled to a lower end of the body of the locking pin and extending down in the inner housing, a length adjusting portion variably coupled at a predetermined position in a longitudinal direction of the extension, and a lever protruding at a side of the length adjusting portion to be held by a hand.

The apparatus may further include a horizontal anti- pushing portion at a predetermined distance around a portion of the body of the locking pin.

The automatic actuator may have a pressing portion moving into and out of the outer housing and the opening of the inner housing when a container is loaded and unloaded, a first locking portion extending down from the pressing portion and pushing down the first flange, and a second locking portion disposed under the first locking portion and pushing up the first flange.

The second locking portion may be coupled to a lower portion of the first locking portion and elastically supported by the first elastic member, and the first locking portion and the second locking portion may be spaced from each other and a portion of the first flange may be received in a space between the first and second locking portions.

The second locking portion may be coupled to a lower portion of the first flange and elastically supported by a second elastic member, and a second flange spaced from the first flange may be formed on the body of the locking pin with the guiding portion therebetween and limit upward movement of the locking pin.

Shock-absorbing projections may be formed on any one of sides facing each other of the second locking portion and the first flange.

The guiding portion of the locking pin may be a spiral groove formed around the body and the end of the guide member may be inserted in the guiding portion.

The guiding portion of the locking pin may be a spiral protrusion formed around the body and the guide members may be provide in a pair with a gap therebetween so that the spiral protrusion is partially received in a space between the guide members.

The guiding portion of the locking pin may be composed of a pair of spiral protrusions formed around the body with a gap therebetween and the end of the guide member is received in a space between the spiral protrusions.

The guiding portion of the locking pin may be a spiral groove formed around the body and the end of the guide member is inserted in the guiding portion.

At least one of both ends of the guiding portions may be bent in an axial direction of the body.

According to another aspect of the present invention, there is provided a locking apparatus of a container for a trailer that can fix a container by automatically or manually coupling the container to a trailer, using a locking pin that is operated by the weight of a container, and can improve stability by preventing movement and separation of a container from a trailer during transportation. The locking apparatus includes: an outer housing mounted on the upper frame and having an opening at least at a side; an inner housing having the shape of a hollow pipe, disposed inside the outer housing with a gap therebetween, and having a guide groove spirally formed at a side; an automatic actuator disposed in the inner housing and moved up and down by a first elastic member and weight of a container; a locking pin having a cylindrical body disposed in the automatic actuator, a head formed at an upper end of the body and inserted in a fastening hole of the container, and a first locking protrusion formed at a portion around the outer side of the body and moved with the automatic actuator moving up and down; a guide member separably inserted toward the automatic actuator through the guide groove of the inner housing to be inserted in a hole formed in the body of the locking pin, and rotating the locking pin when the automatic actuator moves up and down; and a manual actuator having an extension separably coupled to a lower end of the body of the locking pin and extending down in the inner housing, a length adjusting portion variably coupled at a predetermined position in a longitudinal direction of the extension, and a lever protruding at a side of the length adjusting portion to be held by a hand.

The following effects can be expected from the present invention.

First, even if automatic locking and unlocking is not normally made due to malfunction, manual locking and unlocking can performed with ease.

Second, it is possible to improve durability by preventing shock directly applied to the locking pin due to a horizontal load applied to a container and it is also possible to minimize malfunction by simplifying the entire coupling structure.

Third, even if the head of the locking pin is not accurately inserted in a fastening hole of a container and moved down, it is possible to prevent damage to the parts coupled to the locking pin and achieve smooth fastening.

Fourth, it is possible to improve work efficiency in loading/unloading a container by means of the automatic locking function.

Fifth, it is possible to ensure safety by keeping a container fastened during transportation.

Sixth, it is possible to provide convenience for a driver, using the automatic and the manual types.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A and 1B are cross-sectional views shows a manual locking apparatus according to the related art before and after the locking apparatus is operated;

FIGS. 2A and 2A are cross-sectional views shows an automatic locking apparatus according to the related art before and after the locking apparatus is operated;

FIGS. 3A and 3B are cross-sectional view showing a locking apparatus of a container for a trailer according to a first embodiment of the present invention before and after the locking apparatus is operated;

FIGS. 4A and 4B are cross-sectional view showing a locking apparatus of a container for a trailer according to a second embodiment of the present invention before and after the locking apparatus is operated;

FIGS. 5A and 5B are cross-sectional view showing a locking apparatus of a container for a trailer according to a third embodiment of the present invention before and after the locking apparatus is operated;

FIG. 6 is a cross-sectional view showing a locking apparatus of a container for a trailer according to a fourth embodiment of the present invention;

FIG. 7 is a cross-sectional view showing a locking apparatus of a container for a trailer according to a fifth embodiment of the present invention; and

FIG. 8 is a cross-sectional view showing a locking apparatus of a container for a trailer according to a sixth embodiment of the present invention.

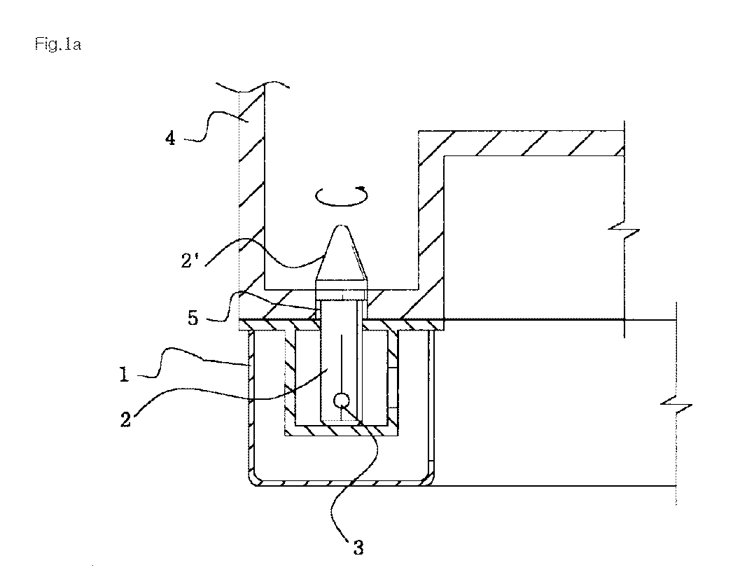

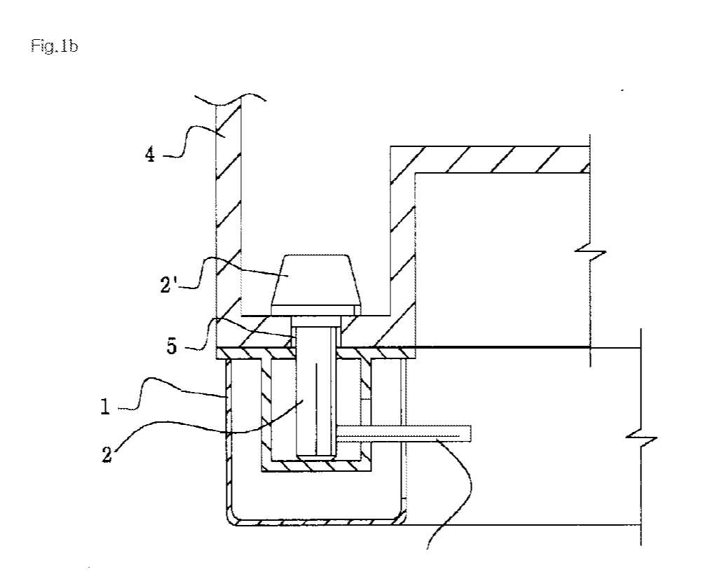

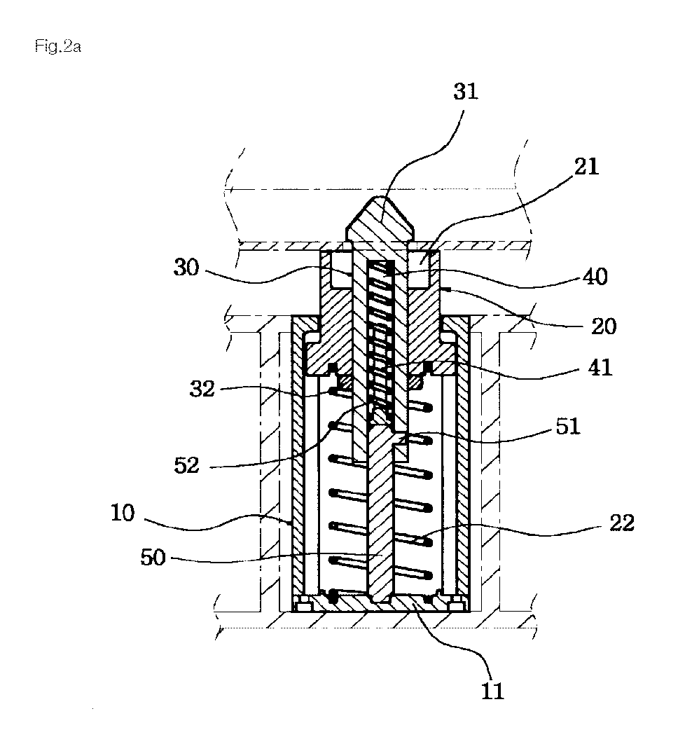

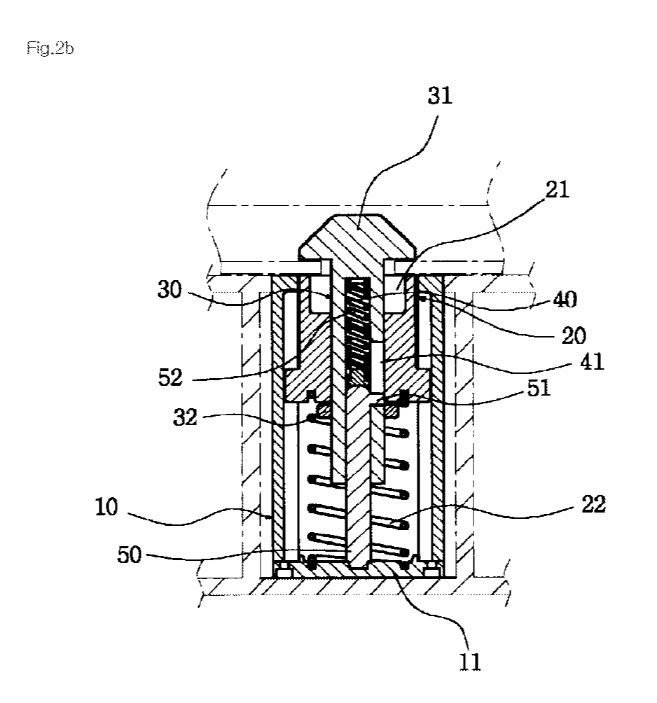

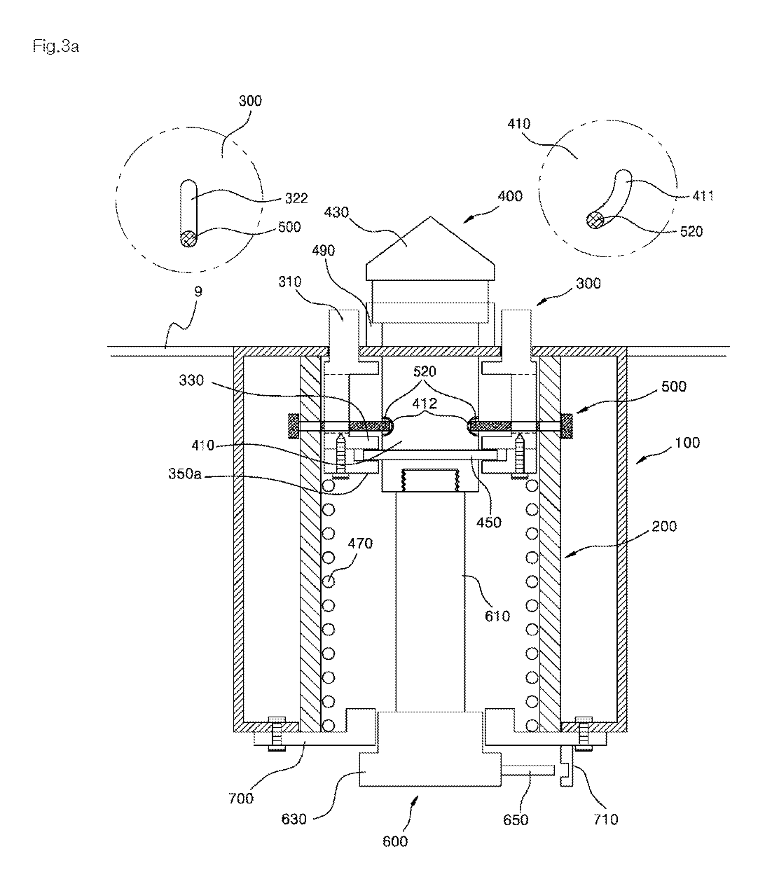

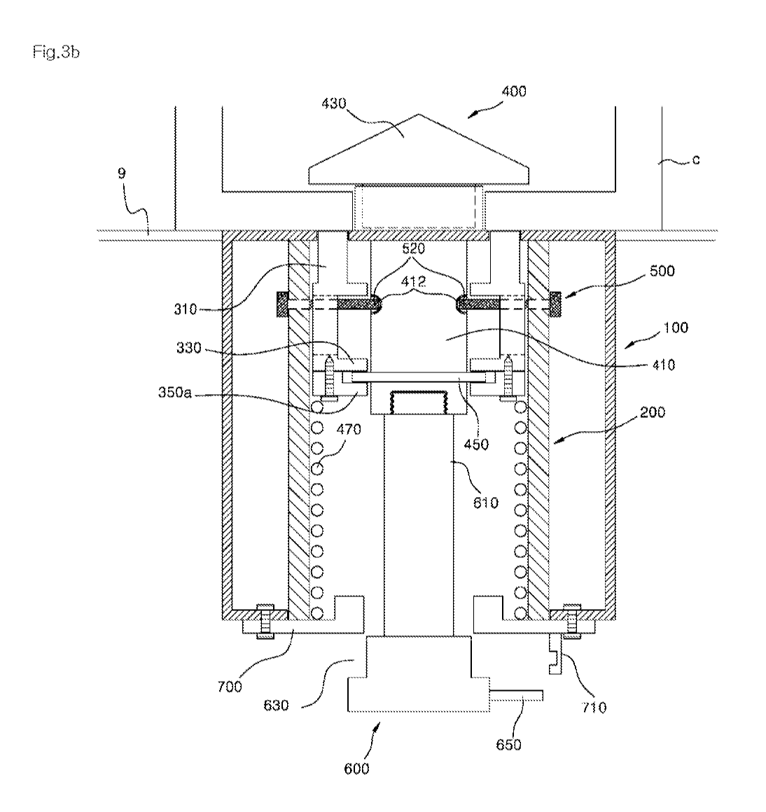

### DETAILED DESCRIPTION OF THE INVENTION

The advantages and features of the present invention, and methods of achieving them will be clear by referring to the exemplary embodiments that will be describe hereafter in detail with reference to the accompanying drawings. However, the present invention is not limited to exemplary embodiments disclosed herein but may be implemented in various different forms. The exemplary embodiments are provided for making the disclosure of the present invention thorough and for fully conveying the scope of the present invention to those skilled in the art. The terminologies used herein are provided for explaining embodiments, not limiting the present invention. Singular terms include plural terms herein, unless specifically stated.

Hereinafter, preferred embodiments of the present invention are described in detail with reference to the accompanying drawings. Configuration, operation, and effect that those skilled in the art can easily understand are simply or not shown and described and the parts relating to the present invention will be described in detail.

The present invention relates to a locking apparatus that is disposed at several positions on the top frame of a trailer and fastens containers to the upper frame, and as shown in FIGS. 3A to 7, the locking apparatus includes: an outer housing 100 that is mounted on a top frame; an inner housing 200 disposed inside the outer housing 100 with a gap therebetween; an automatic actuator 300 that is disposed inside the inner housing 200; a locking pin 400 that is disposed in an opening of the automatic actuator 300; a guide member 500 that rotates the locking pin 400 when the automatic actuator 300 moves up and down; and a manual actuator 600 that rotates the locking pin 400 by hand when the guide member 500 is separated.

These components are organically coupled and operated and detailed configurations of the components provide remarkable effect in organic operation of the locking apparatus, which will be described in detail below.

First, the outer housing 100 is mounted on a top frame 9 and has an opening at least at a side. The opening is not shown in detail in the drawings, but is formed such that the guide member 500 inside is shown from the outside.

A pressing portion 310 of the automatic actuator 300 and a head 430 of the locking pin 400 protrude over the top frame 9 through the outer housing 100. Though not shown in the figures, the inside of the outer housing 100 is formed to correspond to the edge of the pressing portion 310 so that the pressing portion 310 can be smoothly operated up and down within a predetermined range without horizontally separating.

The inner housing 200 is formed in the shape of a hollow pipe and disposed inside the outer housing 100 with a gap therebetween. A fastening hole where the guide member 500 is inserted is formed in the inner housing 200 and a thread is formed on the inner side of the fastening hole to easily couple the guide member 500.

The inner housing 200 is supported by a support member 700 inside the outer housing 100 and the support member 700 has a hole such that the manual actuator 600 can vertically move through it. The support member 700 is coupled to the bottom of the outer housing 100 to be able to support a first elastic member 470 in addition to the inner housing 200.

The automatic actuator 300 is disposed inside the inner housing 200 and moved up and down by the first elastic member 470 and the weight of a container C.

The automatic actuator 300 has the pressing portion 310 that moves into and out of the outer housing 100 and the opening of the inner housing 200 when a container is loaded and unloaded, a first locking portion 330 extending down from the pressing portion 310 and pushing down a first flange 450, and a second locking portion 350 disposed under the first locking portion 330 and pushing up the first flange 450. Various embodiments of the automatic actuator 300 will be described below.

The locking pin 400 has a cylindrical body 310 disposed in the hole of the automatic actuator 300, a head 430 formed at the upper end of the body 410 to be inserted into a fastening hole of a container, the first flange 450 formed at a portion on the outer side of the body 410 to move up and down with the automatic actuator 300, and a guiding portion formed at another portion on the outer side of the body 410 and inducing the body 410 to be rotated with vertical movement of the automatic actuator 300. Various embodiments of the guiding portion will be described below.

A horizontal anti-pushing portion 490 may be further formed at a predetermined position around a portion of the body 410 of the locking pin 400 and is fixed to the outer housing 100 to protect the locking pin 400 inside the outer housing.

That is, the horizontal anti-pushing portion 490 is fixed to the outer housing 100 and surrounds the locking pin 400 to prevent shock that is directly applied to the locking pin due to a horizontal load applied to a container. Accordingly, it can improve durability of the apparatus and minimize malfunction by simplifying the coupling structure.

The guide member 500 is separably inserted toward the automatic actuator 300 from the outside of the inner housing 200 such that an end 520 is coupled to the guiding portion, so the locking pin 400 is rotated when the automatic actuator 300 is moved up and down.

A thread is formed on the outer side of the guide member 500 to be thread-fastened to the coupling hole of the inner housing 200.

Though not shown in the figures, a guide-fixing member may be separably disposed outside the inner housing 200 in contact with at least a portion of the guide member 500, so the guide member 500 can be prevented from separating.

The manual actuator 600 has an extension 610 separably (or integrally) coupled to the lower end of the body 410 of the locking pin 400 or extending downward in the inner housing 200, a length adjusting portion 630 variably coupled to a predetermined position in the longitudinal direction of the extension 610, and a lever 650 protruding at a side of the length adjusting portion 630 to be held by a hand.

The manual actuator 600 is rotated with the automatic actuator 300 when the guide member 500 is coupled to the guiding portion of the locking pin 400, but when the guide member 500 is separated from the guiding portion of the locking pin 400, the manual actuator 600 can rotate regardless of the guiding portion. Accordingly, when the lever 650 is manually operated and rotates the locking pin 400, the head 430 of the locking pin 400 is inserted into or separated from the fastening hole of the container C. Accordingly, even if automatic locking and unlocking is not normally made due to malfunction, manual locking and unlocking can be performed with ease.

A lever-fixing portion 710 for fixing the lever may be formed on the support member 700 and prevents the locking pin 400 that has been locked from rotating by fixing the lever 650 after manual operation.

Hereinafter, various embodiments are described with reference to FIGS. 3A to 7. The configuration described above and repeated configuration are not described and only the differences of the embodiments are described in detail.

### First Embodiment

FIGS. 3A and 3B are cross-sectional view showing a locking apparatus of a container for a trailer according to a first embodiment of the present invention before and after the locking apparatus is operated. FIG. 3A shows the state before operation, that is, before the head 430 is fastened and FIG. 3B shows the state after operation, that is, when the head 430 is rotated and inserted in a fastening hole of the container C by the automatic actuator 300 moving down.

Referring to FIGS. 3A and 3B, the second locking portion 350a of the automatic actuator 300 is coupled to the first locking portion 330 and elastically supported by a first elastic member 470, but the first locking portion 330 and the second locking portion 350a are spaced from each other so that a portion of the first flange 450 can be received in the space between the portions. Accordingly, when the automatic actuator 300 is moved down, the first locking portion 330 pushes down the first flange 450, and when the automatic actuator 300 is moved up, the second locking portion 350a pushes up the first flange 450.

The guiding portion 411 of the locking pin 400 is a spiral groove 411 formed around the body 410 and the end 520 of the guide member 500 can be inserted in the guiding portion 411. In this embodiment, the guiding portions 411 and the guide members 500 are provided in a pair, respectively, but a single guiding portion 411 and a single guide member 500 may be used.

The holes 322 of the automatic actuator 300 through which the guide members 500 are inserted may be longitudinally long holes.

The inner side of the opening of the support member 700 is curved upward to provide a predetermined space, so the first elastic member 470 is can be supported in the space without separating.

### Second Embodiment

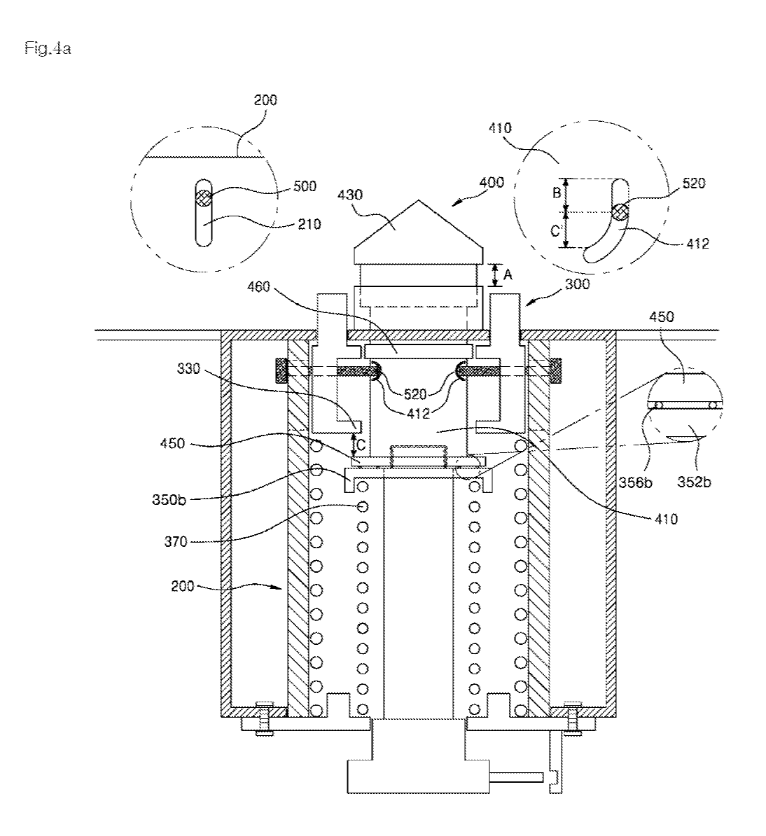

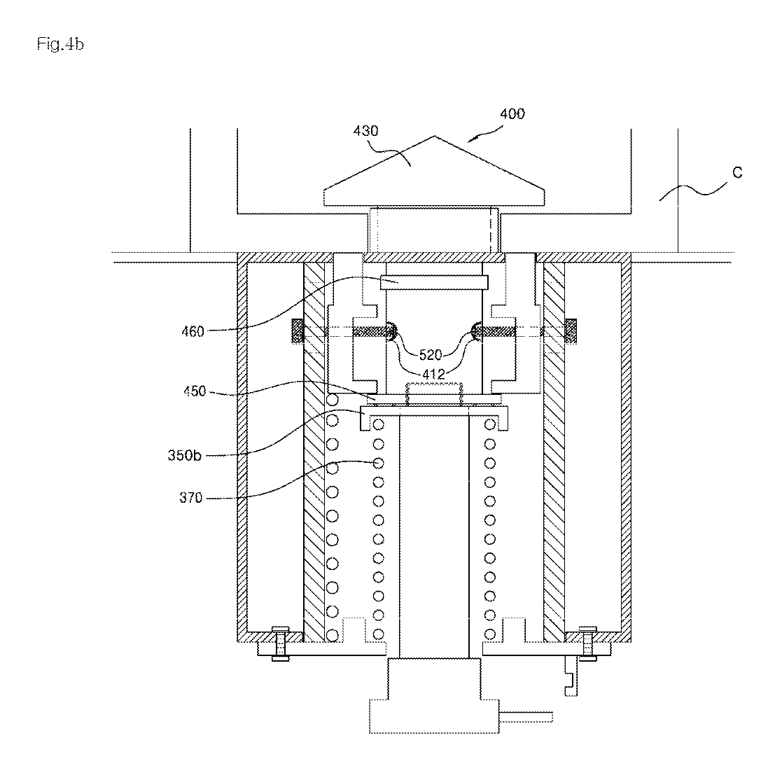

FIGS. 4A and 4B are cross-sectional view showing a locking apparatus of a container for a trailer according to a second embodiment of the present invention before and after the locking apparatus is operated. FIG. 4A shows the state before operation, that is, before the head 430 is fastened and FIG. 4B shows the state after operation, that is, when the head 430 is rotated and inserted in a fastening hole of the container C by the automatic actuator 300 moving down. Referring to FIGS. 4A and 4B, the second locking portion 35b of the automatic actuator 300 is coupled to the bottom of the first flange 450 and elastically supported by a second elastic member 370. Accordingly, when the automatic actuator 300 is moved down, the first locking portion 330 pushes down the first flange 450, and when the automatic actuator 300 is moved up, the second locking portion 350b pushes up the first flange 450. The second elastic member 370 provides elastic force so that the automatic actuator 300 and the locking pin 400 can be smoothly moved up.

The guiding portion 412 of the locking pin 400 is, as in the first embodiment, a spiral groove 412 formed around the body 412 and the end 520 of the guide 500 can be inserted in the guiding portion 412. The holes 210 of the inner housing 200 through which the guide members 500 are inserted may be longitudinally long holes.

Shock-absorbing projections 356b may be formed on any one of the sides facing each other of the second locking portion 350b and the first flange 450 and they distribute shock load and reduce friction between the first locking flange 450 and the second locking portion 350b.

A step is circumferentially formed between the edge of the bottom inside the inner housing 200 and the inner end of support member 700 so that the first elastic member 470 can be supported outside the step and the second elastic member 370 can be supported inside the step in the inner housing 200.

### Third Embodiment

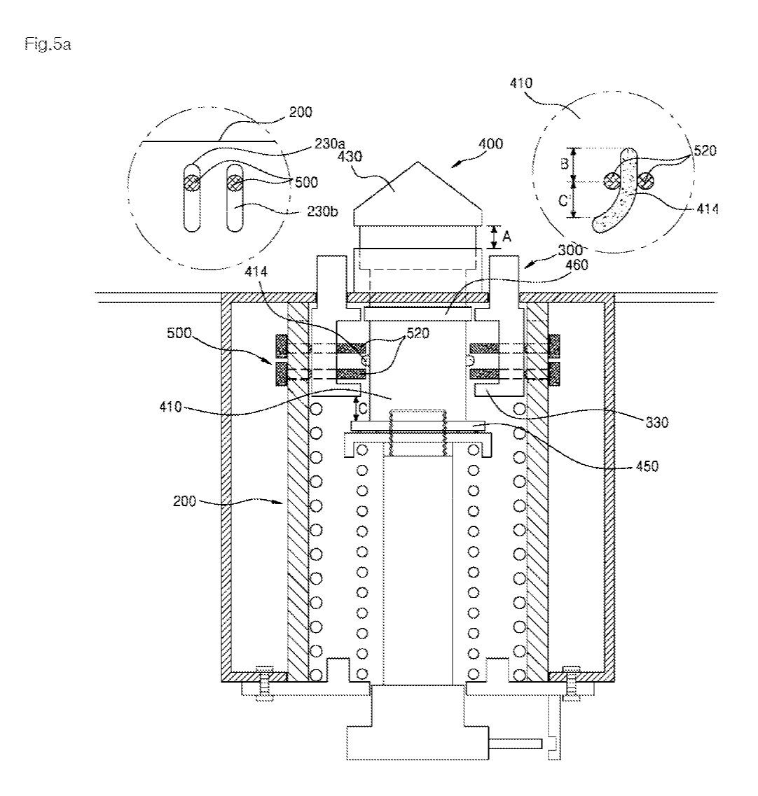

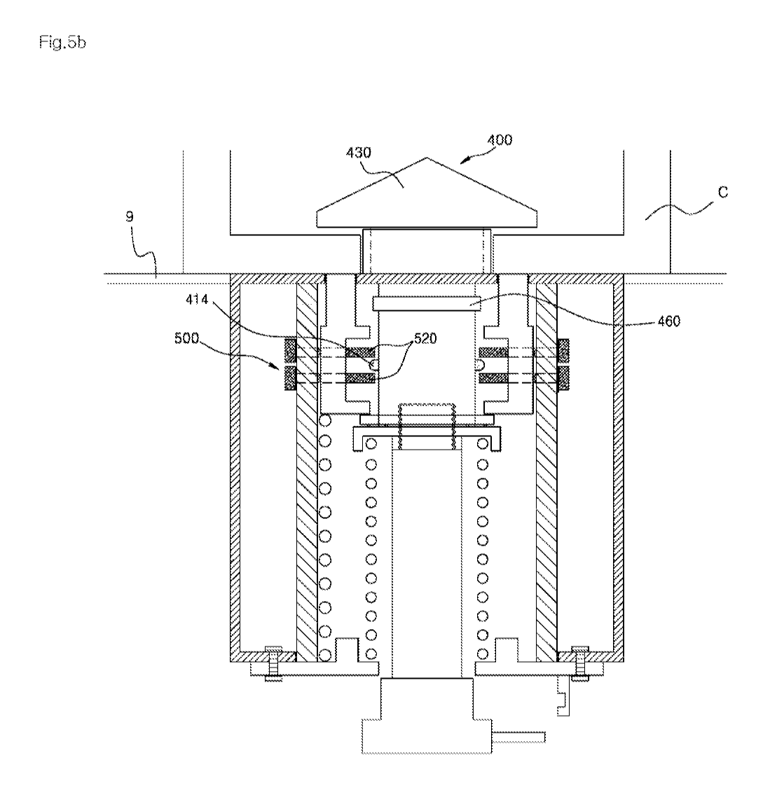

FIGS. 5A and 5B are cross-sectional view showing a locking apparatus of a container for a trailer according to a third embodiment of the present invention before and after the locking apparatus is operated. FIG. 5A shows the state before operation, that is, before the head 430 is fastened and FIG. 5B shows the state after operation, that is, when the head 430 is rotated and inserted in a fastening hole of the container C by the automatic actuator 300 moving down.

Referring to FIGS. 5A and 5B, the guiding portion 414 of the locking pin 400 is a spiral protrusion 414 formed around the body 410 and a pair of guide members 500 is provide with a gap therebetween so that the spiral protrusion 414 can be partially received in the space between the guide members 500. The holes 230a and 230b of the inner housing 200 through which the guide members 500 are inserted may be longitudinally long holes.

### Fourth Embodiment

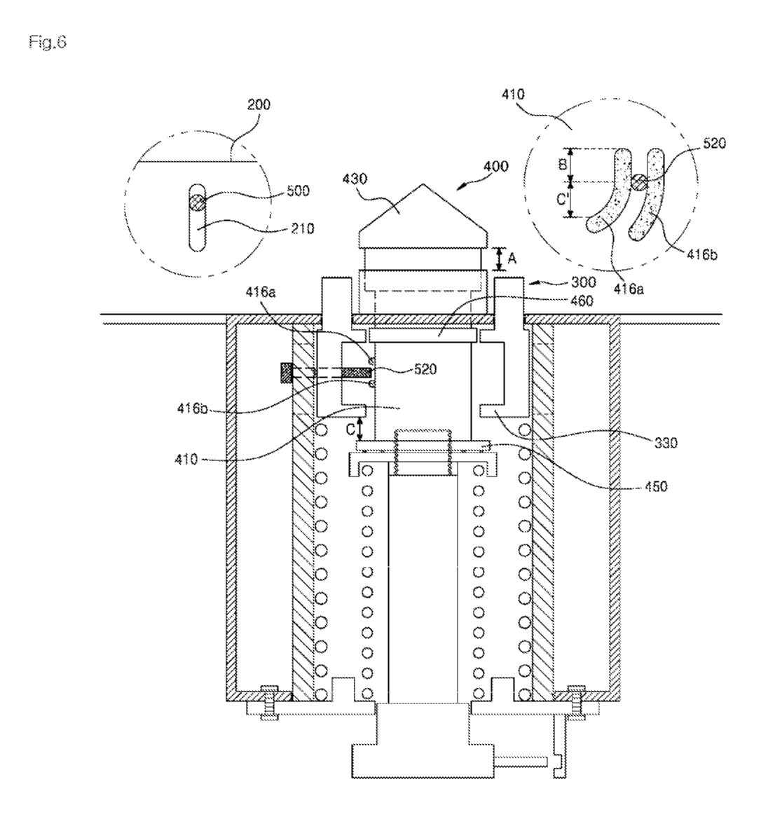

FIG. 6 is a cross-sectional view showing a locking apparatus of a container for a trailer according to a fourth embodiment of the present invention. FIG. 6 is a cross-sectional view showing the state before the locking apparatus is operated and does not provide a cross-sectional view in the state after operation.

Referring to FIG. 6, a guiding portion 416 of the locking pin 400 is composed of a pair of spiral protrusions 416a and 416b formed around the body 410 with a gap therebetween and the end 520 of the guide member 500 can be received in the space between the protrusions. The hole 210 of the inner housing 200 through which the guide member 500 is inserted may be a longitudinally long hole.

### Fifth Embodiment

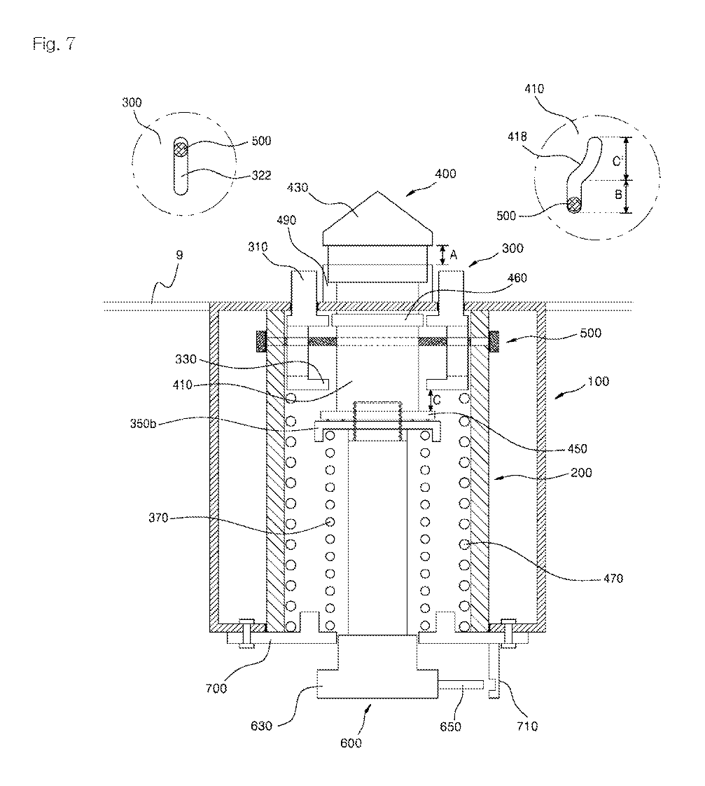

FIG. 7 is a cross-sectional view showing a locking apparatus of a container for a trailer according to a fifth embodiment of the present invention. FIG. 7 is a cross-sectional view showing the state before the locking apparatus is operated and does not provide a cross-sectional view in the state after operation.

Referring to FIG. 7, a guiding portion 418 of the locking pin 400 is a spiral hole 418 formed through the body 410 to receive a portion of the guide member. The holes 322 of the automatic actuator 300 through which the guide members 500 are inserted may be longitudinally long holes.

As shown in FIGS. 4A to 7, at least one of both ends of the guiding portions 412, 414, 416, and 418 may be curved in the axial direction of the body 410.

This is for, as described in “Description of the Related Art” and “SUMMARY OF THE INVENTION, preventing damage to the parts coupled to the locking pin and allowing for smooth fastening even if the head 430 of the locking pin 400 is not accurately inserted in a fastening hole of a container.

That is, even if the automatic actuator 300 or the locking pin 400 is temporarily moved up or down by an external force, the locking pin 400 is not rotated within a predetermined range where it starts moving up or down by the axially curved end.

Accordingly, it is possible to prevent the guide members 500 coupled to the guiding portions 412, 414, and 416 from being damaged by sudden shock or external force.

The length B of the curved ends of the guiding portions 412, 414, and 416 may be the same as the distance A between the lower end of the head 430 and the upper end of the horizontal anti-pushing portion 490 before the locking apparatus is operated, in terms of allowing smooth coupling between the guiding portions 412, 414, and 416 and the guide members 500.

### Sixth Embodiment

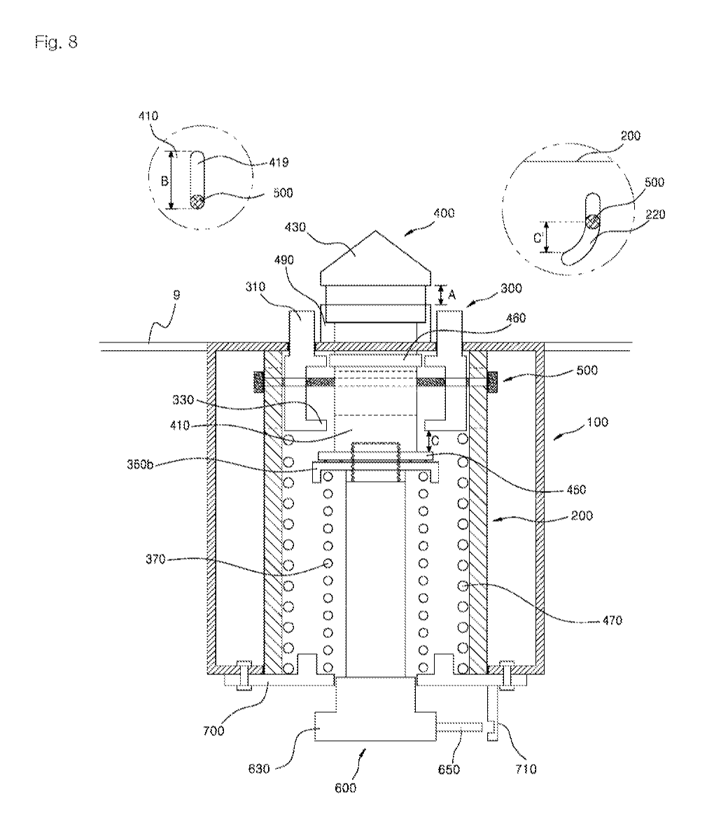

FIG. 8 is a cross-sectional view showing a locking apparatus of a container for a trailer according to a sixth embodiment of the present invention. FIG. 8 is a cross-sectional view showing the state before the locking apparatus is operated and does not provide a cross-sectional view in the state after operation.

The same configuration described above is not described and only the inner housing 200 and the locking pin 400 different from those of the previous embodiments are described.

Referring to FIG. 8, a guide groove 220 is spirally formed through a side of the inner housing 200 and the guide member 500 is separably inserted toward the automatic actuator 300 through the guide groove of the inner housing 200 to be coupled to a hole 419 formed in the body 410 of the locking pin 400. Accordingly, when the automatic actuator 300 is moved up and down, the guide member 500 slides along the guide groove 220 and the locking pin 400 is rotated.

A pair of guide grooves 220 may be formed to face each other to smoothly rotate the locking pin 400.

Further, the holes 419 of the locking pin 400 through which the guide members 500 are inserted may be longitudinally long holes.

As shown in FIGS. 4A to 8, a second flange 460 spacing from the first flange 450 may be formed in the body 410 of the locking pin 400 with the guiding portions 412, 414, and 416 or the hole 419 therebetween to limit upward movement of the locking pin 400.

Accordingly, the upward movement of the locking pin 400 is limited at a predetermined position and a predetermined gap C is maintained between the first locking portion 330 of the automatic actuator 300 and the first flange 450 in order to prevent the head 430 of the locking pin 400 from being rotated and fastened even without being accurately inserted in the fastening hole of a container.

That is, the gap C is a section where the head 430 of the locking pin 400 is inserted into the fastening hole of a container, so when the head 430 of the locking pin 400 not accurately inserted in the fastening hole of a container and moved down, the bottom of the head 430 comes in contact with the horizontal anti-pushing portion 490 and the fastening hole of the container is induced to normally slide, thereby preventing damage to the parts inside.

Accordingly, when the locking pin 400 stops rotating and the head 430 is positioned in the locking direction, the first locking portion 330 pushes down the first flange 450 and moves down the locking pin 400, so the container is completely fastened.

The gap C between the first locking portion 330 and the first flange 450 may be the same as the height C′ of the curved portion of the guiding portions 412, 414, 416, and 418 or the guide groove 220 in order to smoothly fasten a container.

The following effects may be expected from the embodiments of the present invention described above.

First, even if automatic locking and unlocking is not normally made due to malfunction, manual locking and unlocking can be performed with ease.

Second, it is possible to improve durability by preventing shock directly applied to the locking pin due to a horizontal load applied to a container and it is also possible to minimize malfunction by simplifying the entire coupling structure.

Third, even if the head of the locking pin is not accurately inserted in a fastening hole of a container and moved down, it is possible to prevent damage to the parts coupled to the locking pin and achieve smooth fastening.

Fourth, it is possible to improve work efficiency in loading/unloading a container by means of the automatic locking function.

Fifth, it is possible to ensure safety by keeping a container fastened in transportation.

Sixth, it is possible to provide convenience for a driver, using the automatic and the manual types.

The characteristics and technical advantages of the present invention were described in a somewhat wide range so that the following claims can be more easily understood. It should be understood that the present invention may be implemented in other detailed ways by those skilled in the art without changing the scope or necessary features of the present invention. Therefore, the embodiments described above are only examples and should not be construed as being limitative in all respects. The scope of the present invention is defined by not the specification, but the following claims, and all of changes and modifications obtained from the meaning and range of claims and equivalent concepts should be construed as being included in the scope of the present invention.

1. A locking apparatus of a container for a trailer that is disposed at several positions on an upper frame of a trailer to fasten a container on the upper frame, the apparatus comprising:
an outer housing mounted on the upper frame and having an opening at least at a side;
an inner housing having the shape of a hollow pipe and disposed inside the outer housing with a gap therebetween;
an automatic actuator disposed in the inner housing and moved up and down by a first elastic member and weight of a container;
a locking pin having a cylindrical body disposed in the automatic actuator, a head formed at an upper end of the body and inserted in a fastening hole of the container, a first locking protrusion formed at a portion around the outer side of the body and moved with the automatic actuator moving up and down, and a guiding portion formed at another portion around the body and inducing the body to be rotated with the automatic actuator moving up and down;
a guide member separably inserted toward the automatic actuator from the outside of the inner housing such that an end is coupled to the guiding portion and rotating the locking pin when the automatic actuator moves up and down; and
a manual actuator having an extension separably coupled to a lower end of the body of the locking pin and extending down in the inner housing, a length adjusting portion variably coupled at a predetermined position in a longitudinal direction of the extension, and a lever protruding at a side of the length adjusting portion to be held by a hand.

2. The apparatus of claim 1, further comprising a horizontal anti-pushing portion at a predetermined distance around a portion of the body of the locking pin.

3. The apparatus of claim 1, wherein the automatic actuator has a pressing portion moving into and out of the outer housing and the opening of the inner housing when a container is loaded and unloaded, a first locking portion extending down from the pressing portion and pushing down the first flange, and a second locking portion disposed under the first locking portion and pushing up the first flange.

4. The apparatus of claim 3, wherein the second locking portion is coupled to a lower portion of the first locking portion and elastically supported by the first elastic member, and
the first locking portion and the second locking portion are spaced from each other and a portion of the first flange is received in a space between the first and second locking portions.

5. The apparatus of claim 3, wherein the second locking portion is coupled to a lower portion of the first flange and elastically supported by a second elastic member, and
a second flange spaced from the first flange is formed on the body of the locking pin with the guiding portion therebetween and limits upward movement of the locking pin.

6. The apparatus of claim 5, wherein shock-absorbing projections are formed on any one of sides facing each other of the second locking portion and the first flange.

7. The apparatus of claim 1, wherein the guiding portion of the locking pin is a spiral groove formed around the body and the end of the guide member is inserted in the guiding portion.

8. The apparatus of claim 1, wherein the guiding portion of the locking pin is a spiral protrusion formed around the body and the guide members are provide in a pair with a gap therebetween so that the spiral protrusion is partially received in a space between the guide members.

9. The apparatus of claim 1, wherein the guiding portion of the locking pin is composed of a pair of spiral protrusions formed around the body with a gap therebetween and the end of the guide member is received in a space between the spiral protrusions.

10. The apparatus of claim 1, wherein the guiding portion of the locking pin is a spiral groove formed around the body and the end of the guide member is inserted in the guiding portion.

11. The apparatus of claim 7, wherein at least one of both ends of the guiding portions is bent in an axial direction of the body.

12. A locking apparatus of a container for a trailer that is disposed at several positions on an upper frame of a trailer to fasten a container on the upper frame, the apparatus comprising:
an outer housing mounted on the upper frame and having an opening at least at a side;
an inner housing having the shape of a hollow pipe, disposed inside the outer housing with a gap therebetween, and having a guide groove spirally formed at a side;
an automatic actuator disposed in the inner housing and moved up and down by a first elastic member and weight of a container;
a locking pin having a cylindrical body disposed in the automatic actuator, a head formed at an upper end of the body and inserted in a fastening hole of the container, and a first locking protrusion formed at a portion around the outer side of the body and moved with the automatic actuator moving up and down;
a guide member separably inserted toward the automatic actuator through the guide groove of the inner housing to be inserted in a hole formed in the body of the locking pin, and rotating the locking pin when the automatic actuator moves up and down; and
a manual actuator having an extension separably coupled to a lower end of the body of the locking pin and extending down in the inner housing, a length adjusting portion variably coupled at a predetermined position in a longitudinal direction of the extension, and a lever protruding at a side of the length adjusting portion to be held by a hand.

13. The apparatus of claim 8, wherein at least one of both ends of the guiding portions is bent in an axial direction of the body.

14. The apparatus of claim 9, wherein at least one of both ends of the guiding portions is bent in an axial direction of the body.

15. The apparatus of claim 10, wherein at least one of both ends of the guiding portions is bent in an axial direction of the body.
